(19) United States
(12) Patent Application Publication
(10) Pub. No.: US 2005/0173262 A1
(43) Pub. Date: Aug. 11, 2005

(54) Water treatment device

(76) Inventors: Minoru Nakanishi, Otsu-shi (JP); Shigeki Yoshida, Otsu-shi, Shiga (JP); Naoki Hiro, Jyoto-ku, Osaka-shi (JP); Motoki Kouchi, Oizumi-machi (JP); Minoru Kishi, Settsu-shi (JP); Yozo Kawamura, Shimoyama, Minakuchi-cho (JP); Yoshihiro Inamoto, Otsu-shi, Shiga (JP); Tatsuya Hirota, Wake-cho, Shimogyo-ku (JP)

Correspondence Address: RABIN & Berdo, PC, 1101 14TH STREET, NW, SUITE 500, WASHINGTON, DC, 20005, US

(21) Appl. No.: 10/503,330

(22) PCT Filed: Feb. 3, 2003
(86) PCT No.: PCT/JP03/01045

(30) Foreign Application Priority Data
Feb. 4, 2002 (JP) 2002-27070

(51) Int. Cl. C02F 1/461

(52) U.S. Cl. 205/743

(57) ABSTRACT

To provide an apparatus construction which makes it possible to perform a water treatment sequence by automatic control for reducing nitrate (nitrite) ions in water being treated through an electrochemical reaction and substituting nitrogen gas for the resulting ammonia for removal of ammonia from the water; and a detecting method using the apparatus for automatically detecting the progress of reduction or denitrification, or degradation of the treating capability of cathode or anode.

The water treatment apparatus comprises a cathode (15) which reduces nitrate (nitrite) ions through an electrochemical reaction, an anode (16), an electrolytic bath (10) containing the cathode and the anode, and a hydrogen gas sensor (30) which measures a hydrogen gas concentration in the electrolytic bath (10). Water to be treated is introduced into the electrolytic bath (10), and an electric current is applied to the water. The completion of the reduction of the nitrate (nitrite) ions or the degradation of reduction capability of the cathode (15) can be detected on the basis of a value measured by the hydrogen gas sensor (30) or a control electric current value of the electrolytic bath (10).

### TECHNICAL FILED

The present invention relates to a water treatment apparatus for performing a denitrification process through an electrochemical reaction without utilizing a biological denitrification method.

### PRIOR ART

Since nitrogen-containing components such as nitrate ions, nitrite ions and ammonia present in industrial waste water, domestic waste water and ground water are substances causative of water pollution, it is very important to develop means for removing these nitrogen-containing components.

Conventionally, a biological denitrification method employing denitrification bacteria is known as a method for removing oxidized nitrogen-containing components such as nitrate ions and nitrite ions out of the aforesaid nitrogen-containing components. However, biocatalysts such as the denitrification bacteria are problematic in that the capability thereof for removing the nitrogen-containing components significantly varies depending on the season, because the activity thereof is temperature-dependent.

On the other hand, Japanese Unexamined Patent Publication No. HEI11(1999)-347558 discloses a method for removing the nitrogen-containing components through an electrochemical reaction without utilizing the biocatalysts such as the denitrification bacteria.

In a process for removing the nitrogen-containing components through the electrochemical reaction, a nitrate ion reducing reaction represented by the following reaction formula (1) occurs at a cathode, and reactions represented by the following reaction formulae (2) and (3) occur at an anode. In the following reaction formula (4), ammonia generated at the cathode reacts with hypochlorous acid generated at the anode, whereby nitrogen gas is generated to be released.
NO₃⁻+6H₂O+8e⁻→NH₃+9OH⁻ (1)
2Cl⁻→Cl₂+2e⁻ (2)
Cl₂+H₂O→HClO+HCl (3)
2NH₃+3HClO→N₂↑+3HCl+3H₂O (4)

An apparatus for denitrifying water being treated through this electrochemical reaction is free from the problem that the capability for removing the nitrogen-containing components varies depending on the season as in the biological denitrification method, and obviates the need for the maintenance of the biocatalysts.

In the denitrification process utilizing the electrochemical reaction, however, the energization level of an electrolytic bath and the amount of electrolytes dissolved in the water being treated should precisely be controlled and regulated. If the control and the regulation are insufficient, the following problems may arise: the nitrate ion reducing reaction does not proceed; an excessively great electric current flows to damage the electrode pair; and ammonia having higher toxicity than nitrate ions is contained in a high concentration in the treated water.

### DISCLOSURE OF THE INVENTION

It is therefore an object of the present invention to provide an apparatus construction which makes it possible to efficiently perform a water treatment sequence by automatic control for reducing nitrate (nitrite) ions in water being treated through an electrochemical reaction and converting the resulting ammonia into nitrogen gas for removal of ammonia from the water.

(First Water Treatment Apparatus)

A first water treatment apparatus according to the present invention for solving the aforesaid problems comprises: a cathode which reduces nitrate (nitrite) ions through an electrochemical reaction; an anode; an electrolytic bath containing the cathode and the anode; a hydrogen gas sensor which measures a hydrogen gas concentration in the electrolytic bath; and reduction completion detecting means which detects completion of the reduction of the nitrate (nitrite) ions on the basis of a measurement value of the hydrogen gas sensor and a control electric current level of the electrolytic bath.

The first water treatment apparatus includes the hydrogen gas sensor. Therefore, the concentration of hydrogen gas generated in the electrolytic bath can be measured for monitoring a change in the concentration with time, while a water treatment sequence is performed for reducing the nitrate (nitrite) ions into ammonia in water being treated through the electrochemical reaction and decomposing the resulting ammonia into nitrogen gas for removal of ammonia. (i) If the hydrogen gas concentration is low with respect to the control electric current level (if the hydrogen gas concentration in the electrolytic bath is lower than a concentration level estimated on the basis of the level of the control electric current flowing through the cathode and the anode) in the water treatment sequence, it is judged that the nitrate (nitrite) ions are present in a greater amount in the water being treated. On the other hand, (ii) if the hydrogen gas concentration is high with respect to the control electric current level (if the hydrogen gas concentration in the electrolytic bath is higher than the concentration level estimated on the basis of the control electric current level), it is judged that the nitrate (nitrite) ions are present in a smaller amount in the water being treated.

Thus, the reduction completion detecting means can judge which of either the conditions (i) or (ii) is satisfied on the basis of the level of the control electric current flowing through the cathode and the anode, the hydrogen gas concentration in the electrolytic bath measured by the hydrogen gas sensor and data of a correlation between the control electric current level and the hydrogen gas concentration in the first inventive water treatment apparatus. If it is judged that the condition (i) is satisfied, the reaction is terminated according to judgment that the reduction of the nitrate (nitrite) ions is completed. This makes it possible to prevent unnecessary implementation of the electrochemical reaction and associated wasteful costs. On the other hand, if it is judged that the condition (ii) is satisfied, the reaction is continued or started according to judgment that the reduction is not completed.

Thus, the first inventive water treatment apparatus has an advantageous construction for efficiently performing the aforesaid water treatment sequence through automatic control by automatically detecting the completion of the reduction of the nitrate (nitrite) ions.

As described above, the use of the first water treatment apparatus makes it possible to automatically detect the completion of the reduction of the nitrate (nitrite) ions in the aforesaid water treatment sequence.

That is, a method for detecting the completion of the reduction is characterized by: introducing water to be treated into the electrolytic bath of the first water treatment apparatus; measuring the hydrogen gas concentration in the electrolytic bath while energizing the electrolytic bath; and detecting the completion of the reduction of the nitrate (nitrite) ions on the basis of the measured hydrogen gas concentration level and the control electric current level of the electrolytic bath.

In the aforesaid water treatment sequence, the detection method includes the step of measuring the concentration of the hydrogen gas generated in the electrolytic bath by the hydrogen gas sensor for monitoring the change in the hydrogen gas concentration in the electrolytic bath with time. The control electric current level, the hydrogen gas concentration in the electrolytic bath, the data of the correlation between the control electric current level and the hydrogen gas concentration, and the reduction completion detecting means are utilized for the detection of the completion of the reduction based on the measured hydrogen gas concentration level and the control electric current level as in the first water treatment apparatus. This detection method is an advantageous method for automatically judging the completion of the reduction of the nitrate (nitrite) ions in the automatic control of the water treatment apparatus employing a denitrification process.

(Second Water Treatment Apparatus)

A second water treatment apparatus according to the present invention for solving the aforesaid problems comprises: a cathode which reduces nitrate (nitrite) ions through an electrochemical reaction; an anode; an electrolytic bath containing the cathode and the anode; a hydrogen gas sensor which measures a hydrogen gas concentration in the electrolytic bath; and reduction capability detecting means which detects degradation of a reduction capability of the cathode on the basis of a measurement value of the hydrogen gas sensor.

The second water treatment apparatus includes the hydrogen gas sensor. Therefore, the concentration of hydrogen gas generated in the electrolytic bath can be measured for monitoring a change in the concentration with time, while the aforesaid water treatment sequence is performed, as in the first inventive water treatment apparatus. In the second water treatment apparatus, the degradation of the capability of the cathode for reducing the nitrate (nitrite) ions can be detected on the basis of the measurement value of the hydrogen gas sensor and the concentration change with time. For example, it is possible: (I) to estimate the concentration of the nitrate (nitrite) ions contained in water being treated on the basis of a level of a control electric current flowing through the electrolytic bath when the hydrogen gas concentration in the electrolytic bath measured by the hydrogen gas sensor is equal to a predetermined level; (II) to estimate an energization time required for reducing the nitrate (nitrite) ions contained in the water being treated on the basis of the control electric current level, the estimated nitrate (nitrite) ion concentration and data of the capability of the cathode for reducing the nitrate (nitrite) ions; and (III) to detect the degradation of the reduction capability of the cathode on the basis of a difference between the energization time estimated to be required for the reduction and an energization time actually required for the completion of the reduction.

For performing the steps (I) to (III), the second water treatment apparatus preferably further comprises:
nitrate (nitrite) ion concentration estimating means which estimates the nitrate (nitrite) ion concentration of the water being treated on the basis of the measurement value of the hydrogen gas sensor and the control electric current level of the electrolytic bath; and
required energization time estimating means which estimates the energization time required for reducing the nitrate (nitrite) ions contained in the water being treated on the basis of the nitrate (nitrite) ion concentration estimated by the nitrate (nitrite) ion concentration estimating means, the control electric current level, and the level of the reduction capability of the cathode;
wherein the reduction capability detecting means detects the degradation of the reduction capability of the cathode on the basis of the difference between the required energization time estimated by the required energization time estimating means and the actually required energization time.

In the second water treatment apparatus, as described above, the difference between the time estimated to be required for the reduction of the nitrate (nitrite) ions in the water being treated through the electrochemical reaction and the time actually required for the reduction is determined with the use of the hydrogen gas sensor and the reduction capability detecting means, whereby the degradation of the reduction capability of the cathode can automatically be detected at an early stage. Further, the need for the replacement of the cathode can automatically be judged.

Thus, the second inventive water treatment apparatus and the preferred embodiment thereof each have an advantageous construction for efficiently performing the aforesaid water treatment sequence through automatic control.

As described above, the use of the second water treatment apparatus makes it possible to automatically detect the degradation of the reduction capability of the cathode in the aforesaid water treatment sequence.

That is, a method for detecting the degradation of the reduction capability is characterized by: introducing water to be treated into the electrolytic bath of the second water treatment apparatus; measuring the hydrogen gas concentration in the electrolytic bath while energizing the electrolytic bath; and detecting the degradation of the reduction capability of the cathode on the basis of the measured concentration level.

In the aforesaid water treatment sequence, the detection method includes the step of measuring the concentration of the hydrogen gas generated in the electrolytic bath by the hydrogen gas sensor for monitoring the change in the hydrogen gas concentration in the electrolytic bath with time. The control electric current level, the hydrogen gas concentration in the electrolytic bath, data of a correlation between the control electric current level and the hydrogen gas concentration, and the nitrate (nitrite) ion concentration estimating means may be utilized for the estimation of the nitrate (nitrite) ion concentration of the water being treated as in the second water treatment apparatus.

For performing the steps (I) to (III) as described above, the detection method preferably comprises: estimating the nitrate (nitrite) ion concentration of the water being treated on the basis of the measurement value of the hydrogen gas sensor and the control electric current level of the electrolytic bath; estimating the energization time required for the reduction of the nitrate (nitrite) ions contained in the water being treated on the basis of the control electric current level, the estimated nitrate ion concentration and the level of the reduction capability of the cathode; and detecting the degradation of the reduction capability of the cathode on the basis of the difference between the estimated required energization time and the actually required energization time.

These detection methods are advantageous methods for automatically detecting the degradation of the reduction capability of the cathode in the automatic control of the water treatment apparatus.

(Third Water Treatment Apparatus)

A third water treatment apparatus according to the present invention for solving the aforesaid problems comprises:
an anode which generates chlorine from chloride ions through an electrochemical reaction;
a cathode;
an electrolytic bath containing the anode and the cathode;
a residual chlorine sensor which measures a residual chlorine concentration of water contained in the electrolytic bath for treatment; and
denitrification completion detecting means which detects completion of denitrification on the basis of a measurement value of the residual chlorine sensor.

The third water treatment apparatus includes the residual chlorine sensor. Therefore, the concentration of residual chlorine contained in the water being treated can be measured for monitoring a change in the concentration with time, while the aforesaid water treatment sequence is performed.

In the aforesaid water treatment sequence, the water being treated is required to contain the residual chlorine for decomposing ammonia into nitrogen gas through a reaction of ammonia with chlorine. Therefore, it is a conventional practice to employ, for example, a process for introducing chloride ions into the water being treated to generate hypochlorous acid (ions) through a reaction at the anode, or a process for introducing hypochlorous acid (ions) directly into the water being treated. Since hypochlorous acid (ions) introduced or generated in the water is consumed in the course of the denitrification, the amount of hypochlorous acid is reduced with time. Therefore, (a) if the concentration of the residual chlorine such as hypochlorous acid (ions) measured by the residual chlorine sensor is not varied or is increased above a predetermined level, it is judged that the water being treated does not contain ammonia in an amount that requires the denitrification (or in an amount such that the denitrification by the electrochemical reaction is possible). On the other hand, (b) if the measured residual chlorine concentration is gradually reduced below the predetermined level, it is judged that the water being treated contains ammonia in an amount that requires the denitrification.

Thus, it is possible to judge whether or not ammonia to be denitrified is present (i.e., which of the conditions (a) and (b) is satisfied) on the basis of the residual chlorine concentration of the water measured by the residual chlorine sensor in the third inventive water treatment apparatus. If it is judged that the condition (a) is satisfied, the reaction is terminated according to judgment that the denitrification (decomposition and removal of ammonia) is completed. That is, the completion of the denitrification can be detected. On the other hand, if it is judged that the condition (b) is satisfied, the reaction is continued or allowed to proceed according to judgment that the denitrification is not completed.

Thus, the third inventive water treatment apparatus has an advantageous construction for efficiently performing the aforesaid water treatment sequence through automatic control by automatically judging the completion of the denitrification.

The third water treatment apparatus preferably further comprises a hydrogen gas sensor which measures a hydrogen gas concentration in the electrolytic bath, wherein the denitrification completion detecting means detects the completion of the denitrification on the basis of the measurement value of the residual chlorine sensor and a measurement value of the hydrogen gas sensor.

In the reduction and denitrification of nitrate (nitrite) ions through the electrochemical reaction, a reaction for reducing the nitrate (nitrite) ions (a reaction for generating ammonia) mainly occurs at the cathode, if the nitrate (nitrite) ion concentration of the water being treated is higher than a predetermined level. On the other hand, if the nitrate (nitrite) ion concentration is decreased and the ammonia concentration is decreased due to the decomposition of ammonia as a reduction product, electrolysis of water mainly occurs at the cathode to generate hydrogen.

Therefore, the completion of the denitrification can more accurately be detected by monitoring the changes in the residual chlorine concentration and the hydrogen gas concentration in the electrolytic bath in accordance with the preferred embodiment of the third water treatment apparatus.

As described above, the use of the third water treatment apparatus makes it possible to automatically detect the completion of the denitrification in the aforesaid water treatment sequence.

That is, a method for detecting the completion of the reaction is characterized by: introducing water to be treated into the electrolytic bath of the third water treatment apparatus; measuring the residual chlorine concentration of the water being treated while energizing the electrolytic bath; and detecting the completion of the denitrification on the basis of the measured residual chlorine concentration level.

In the aforesaid water treatment sequence, the detection method includes the step of measuring the residual chlorine concentration of the water being treated by the residual chlorine sensor for monitoring the change in the residual chlorine concentration of the water with time. The change in the measurement value of the residual chlorine sensor with time may be utilized for the detection of the completion of the denitrification as in the third water treatment apparatus.

The detection method more preferably comprises: introducing the water to be treated into the electrolytic bath of the preferred embodiment of the water treatment apparatus; measuring the residual chlorine concentration of the water and the hydrogen gas concentration in the electrolytic bath while energizing the electrolytic bath; and detecting the completion of the denitrification on the basis of the measured residual chlorine concentration level and the measured hydrogen gas concentration level.

These detection methods are advantageous methods for automatically judging the completion of the denitrification in the automatic control of the water treatment apparatus.

(Fourth Water Treatment Apparatus)

A fourth water treatment apparatus according to the present invention for solving the aforesaid problems comprises:
an anode which generates chlorine from chloride ions through an electrochemical reaction;
a cathode;
an electrolytic bath containing the anode and the cathode;
a residual chlorine sensor which measures a residual chlorine concentration of water contained in the electrolytic bath for treatment; and
residual chlorine generating capability detecting means which detects degradation of a residual chlorine generating capability of the anode on the basis of a measurement value of the residual chlorine sensor.

The fourth water treatment apparatus includes the residual chlorine sensor and the residual chlorine generating capability detecting means. Therefore, the concentration of residual chlorine contained in the water being treated can be measured for monitoring a change in the concentration with time, while the aforesaid water treatment sequence is performed. Further, the degradation of the residual chlorine generating capability of the anode can automatically be detected on the basis of the measured concentration level and the concentration change with time.

For example, the amount of residual chlorine required for reducing nitrate (nitrite) ions into ammonia in the water being treated is estimated on the basis of the concentration of the nitrate (nitrite) ions in the water and the residual chlorine concentration measured by the residual chlorine sensor. In turn, the amount of chloride ions required for generating hypochlorous acid (ions) in the required residual chlorine amount is estimated. With reference to data of the chloride ion generating capability of the anode, a chloride ion source (e.g., a saline solution) is introduced into the electrolytic bath in an amount appropriate for the generation of the hypochlorous acid (ions). If the amount of chloride ions actually introduced for the reduction is greater than the chloride ion amount estimated to be required for the reduction of the nitrate (nitrite) ions, it is judged that the capability of the anode for generating the residual chlorine such as hypochlorous acid (ions) is degraded.

For easier and more accurate judgment on the degradation of the residual chlorine generating capability of the anode, the fourth water treatment apparatus preferably further comprises:
required residual chlorine amount estimating means which estimates a residual chlorine amount required for decomposing ammonia as a reduction product of the nitrate (nitrite) ions into nitrogen gas on the basis of the measurement value of the residual chlorine sensor and the amount of the nitrate (nitrite) ions in the water being treated,
wherein the residual chlorine generating capability detecting means detects the degradation of the residual chlorine generating capability of the anode on the basis of a difference between the required residual chlorine amount estimated by the required residual chlorine amount estimating means and an actually required residual chlorine amount.

In the preferred embodiment of the fourth inventive water treatment apparatus, the amount of the nitrate (nitrite) ions in the water being treated may be determined, for example, through actual measurement by a nitrate (nitrite) ion meter or the like, or through estimation on the basis of a control electric current level of the electrolytic bath and the hydrogen gas amount in the electrolytic bath.

The fourth water treatment apparatus and the preferred embodiment thereof each have an advantageous construction for efficiently performing the aforesaid water treatment sequence through automatic control.

As described above, the use of the fourth water treatment apparatus makes it possible to automatically detect the degradation of the residual chlorine generating capability of the anode in the aforesaid water treatment sequence.

That is, a detection method is characterized by: introducing water to be treated into the electrolytic bath of the fourth water treatment apparatus; measuring the residual chlorine concentration of the water being treated while energizing the electrolytic bath; and detecting the degradation of the residual chlorine generating capability of the anode on the basis of the measured residual chlorine concentration level.

In the aforesaid water treatment sequence, the detection method includes the step of measuring the residual chlorine concentration of the water being treated by the residual chlorine sensor for monitoring the change in the residual chlorine concentration of the water with time. The degradation of the residual chlorine generating capability of the anode may be detected, for example, by estimating the residual chlorine amount required for the reduction, determining the residual chlorine amount actually required for the reduction on the basis of the actually measured amount of the residual chlorine in the water being treated, and comparing the actually required residual chlorine amount with the estimated amount, as in the fourth water treatment apparatus.

For easier and more accurate judgment, the detection method preferably comprises: estimating the residual chlorine amount required for decomposing ammonia as the reduction product of the nitrate (nitrite) ions into nitrogen gas on the basis of the measured residual chlorine concentration level and the nitrate (nitrite) ion amount in the water being treated; and detecting the degradation of the residual chlorine generating capability of the anode on the basis of the difference between the estimated required residual chlorine amount and the actually required residual chlorine amount.

These detection methods are advantageous methods for automatically judging the degradation of the hypochlorous acid generating capability of the anode in the automatic control of the water treatment apparatus.

(Fifth Water Treatment Apparatus)

A fifth water treatment apparatus according to the present invention for solving the aforesaid problems comprises:
a cathode which reduces nitrate (nitrite) ions through an electrochemical reaction;
an anode;
an electrolytic bath containing the cathode and the anode;
a nitrate (nitrite) ion meter which measures a nitrate ion concentration of water contained in the electrolytic bath for treatment; and
reduction completion detecting means which detects completion of the reduction of the nitrate (nitrite) ions on the basis of a measurement value of the nitrate (nitrite) ion meter.

The fifth water treatment apparatus includes the nitrate ion meter and/or the nitrite ion meter. Therefore, the concentration of nitrate (nitrite) ions contained in the water being treated can be measured for monitoring a change in the concentration with time, while the aforesaid water treatment sequence is performed. If the nitrate (nitrate) ion concentration of the water measured by the nitrate (nitrite) ion meter is at a low level at which neither the reduction to ammonia nor the denitrification is required in the aforesaid water treatment sequence, the water treatment can automatically be terminated without unnecessary implementation of the electrolysis. That is, the completion of the reduction of the nitrate (nitrite) ions can be detected on the basis of the measurement value of the nitrate (nitrite) ion meter. On the other hand, if the nitrate (nitrite) ion concentration is at a high level at which the reduction is required, it is automatically judged that the electrolysis should be continued or allowed to proceed.

Thus, the fifth inventive water treatment apparatus has an advantageous construction for efficiently performing the aforesaid water treatment sequence through automatic control.

As described above, the use of the fifth water treatment apparatus makes it possible to detect the completion of the reduction of the nitrate (nitrite) ions in the aforesaid water treatment sequence.

That is, such a detection method is characterized by: introducing water to be treated into the electrolytic bath of the fifth water treatment apparatus; measuring the nitrate (nitrite) ion concentration of the water being treated while energizing the electrolytic bath; and detecting the completion of the reduction of the nitrate (nitrite) ions on the basis of the measured nitrate (nitrite) ion concentration level.

In the aforesaid water treatment sequence, the detection method includes the step of measuring the nitrate (nitrite) ion concentration of the water being treated by the nitrate (nitrite) ion meter for monitoring the change in the nitrate (nitrite) ion concentration of the water with time. The detection method is an advantageous method for automatically judging the completion of the water treatment in the automatic control of the water treatment apparatus.

(Sixth Water Treatment Apparatus)

A sixth water treatment apparatus according to the present invention for solving the aforesaid problems comprises:
a cathode which reduces nitrate (nitrite) ions through an electrochemical reaction;
an anode;
an electrolytic bath containing the cathode and the anode;
a nitrate (nitrite) ion meter which measures a nitrate (nitrite) ion concentration of water contained in the electrolytic bath for treatment; and
ammonia generating capability detecting means which detects degradation of an ammonia generating capability of the cathode on the basis of a measurement value of the nitrate (nitrite) ion meter.

The sixth water treatment apparatus includes the nitrate ion meter and/or the nitrite ion meter and the ammonia generating capability detecting means. Therefore, the concentration of nitrate (nitrite) ions contained in the water being treated can be measured for monitoring a change in the concentration with time, while the aforesaid water treatment sequence is performed. Further, the degradation of the ammonia generating capability of the cathode can automatically be detected on the basis of the measured concentration level and the concentration change with time.

For example, the amount of ammonia generated by the reduction of the nitrate (nitrite) ions in the water being treated and the amount of effective chlorine (e.g., hypochlorous acid (ions) or the like) required for decomposing ammonia into nitrogen gas are first estimated on the basis of the measurement value of the nitrate (nitrite) ion meter, and the effective chlorine is introduced into the electrolytic bath. If the nitrate (nitrite) ion concentration is not decreased or the decrease rate is lower than expected when the effective chlorine such as hypochlorous acid (ions) is introduced, it is judged that the ammonia generating capability of the cathode is degraded.

For easier and more accurate judgment on the degradation of the ammonia generating capability of the cathode, the sixth water treatment apparatus preferably further comprises:
required effective chlorine amount estimating means which estimates the effective chlorine amount required for decomposing ammonia resulting from the reduction of the nitrate (nitrite) ions into nitrogen gas on the basis of the measurement value of the nitrate (nitrite) ion meter,
wherein the ammonia generating capability detecting means detects the degradation of the ammonia generating capability of the cathode on the basis of a difference between the required effective chlorine amount estimated by the required effective chlorine amount estimating means and an actually required effective chlorine amount.

As described above, the sixth inventive water treatment apparatus and the preferred embodiment thereof each have an advantageous construction for efficiently performing the aforesaid water treatment sequence through automatic control.

As described above, the use of the sixth water treatment apparatus makes it possible to automatically detect the degradation of the ammonia generating capability of the cathode in the aforesaid water treatment sequence.

That is, such a detection method is characterized by: introducing water to be treated into the electrolytic bath of the sixth water treatment apparatus; measuring the nitrate (nitrite) ion concentration of the water being treated while energizing the electrolytic bath; and detecting the degradation of the ammonia generating capability of the cathode on the basis of the measured nitrate (nitrite) ion concentration level.

In the aforesaid water treatment sequence, the detection method includes the step of measuring the nitrate (nitrite) ion concentration of the water being treated by the nitrate (nitrite) ion meter for monitoring the change in the nitrate (nitrite) ion concentration of the water with time. The degradation of the ammonia generating capability of the cathode may be detected, for example, by determining the amount of ammonia resulting from the reduction of the nitrate (nitrite) ions in the water being treated and the amount of the effective chlorine (residual chlorine) required for decomposing ammonia on the basis of the measured nitrate (nitrite) ion concentration level of the water, and comparing the estimated effective chlorine amount with the actually required effective chlorine amount as in the sixth water treatment apparatus.

For easier and more accurate judgment, the detection method preferably comprises: introducing the water to be treated into the electrolytic bath of the preferred embodiment of the water treatment apparatus; estimating the effective chlorine amount required for decomposing ammonia resulting from the reduction of the nitrate (nitrite) ions into nitrogen gas on the basis of the measured nitrate ion concentration level; and detecting the degradation of the ammonia generating capability of the cathode on the basis of the difference between the estimated required effective chlorine amount and the actually required effective chlorine amount.

These detection methods are advantageous methods for automatically judging the degradation of the ammonia generating capability of the cathode in the automatic control of the water treatment apparatus.

The aforesaid second water treatment apparatus is adapted to detect the degradation of the reduction capability of the cathode on the basis of the measurement value of the hydrogen gas sensor, and the preferred embodiment thereof is adapted to estimate the nitrate (nitrite) ion concentration of the water being treated on the basis of the hydrogen gas concentration and the control electric current level, estimate the energization time required for the reduction, and detect the degradation of the reduction capability of the cathode on the basis of the difference between the estimated energization time and the actual energization time. The sixth water treatment apparatus is adapted to detect the degradation of the reduction capability of the cathode on the basis of the measurement value of the nitrate (nitrite) ion meter, and the preferred embodiment thereof is adapted to estimate the effective chlorine amount required for the reduction on the basis of the measured nitrate (nitrite) ion concentration level, and detect the degradation of the reduction capability of the cathode on the basis of the difference between the estimated required effective chlorine amount and the actually required effective chlorine amount.

Alternatively, the degradation of the reduction capability of the cathode may be detected on the basis of the measured nitrate (nitrite) ion concentration level, the control electric current level, and the estimated and measured energization times required for the reduction.

A water treatment apparatus suitable for such a case comprises:
a cathode which reduces nitrate (nitrite) ions through an electrochemical reaction;
an anode;
an electrolytic bath containing the cathode and the anode;
a nitrate (nitrite) ion meter which measures a concentration of nitrate (nitrite) ions in water contained in the electrolytic bath for treatment;
required energization time estimating means which estimates an energization time required for the reduction of the nitrate (nitrite) ions contained in the water being treated on the basis of a measurement value of the nitrate (nitrite) ion meter, a control electric current level and a level of a reduction capability of the cathode; and
reduction capability detecting means which detects degradation of the reduction capability of the cathode on the basis of a difference between the required energization time estimated by the required energization time estimating means and an actually required energization time.

The aforesaid water treatment apparatus can estimate the energization time required for the reduction on the basis of the measured nitrate (nitrite) ion concentration level and the control electric current level. That is, the steps (I) and (II) in the preferred embodiment of the second water treatment apparatus can be performed without the use of the hydrogen gas sensor.

The use of the water treatment apparatus makes it possible to automatically detect the degradation of the reduction capability of the cathode in the aforesaid water treatment sequence. That is, the reduction capability detecting method is characterized by: introducing the water to be treated into the electrolytic bath of the water treatment apparatus; measuring the nitrate (nitrite) ion concentration of the water being treated while energizing the electrolytic bath; estimating the energization time required for the reduction of the nitrate (nitrite) ions contained in the water being treated on the basis of the measured nitrate (nitrite) ion concentration level, the control electric current level of the electrolytic bath and the reduction capability level of the cathode; and detecting the degradation of the reduction capability of the cathode on the basis of the difference between the estimated required energization time and the actually required energization time. This detection method is an advantageous method for automatically detecting the degradation of the reduction capability of the cathode in the automatic control of the water treatment apparatus.

(Seventh Water Treatment Apparatus)

A seventh water treatment apparatus according to the present invention for solving the aforesaid problems comprises:
an anode which generates chlorine from chloride ions through an electrochemical reaction;
a cathode;
an electrolytic bath containing the anode and the cathode;
an ammonia meter which measures an ammonia concentration of water contained in the electrolytic bath for treatment; and
decomposition completion detecting means which detects completion of decomposition of ammonia on the basis of a measurement value of the ammonia meter.

The seventh water treatment apparatus includes the ammonia meter. Therefore, the concentration of ammonia contained in the water being treated can be measured for monitoring a change in the concentration with time, while the aforesaid water treatment sequence is performed.

If the ammonia concentration of the water measured by the ammonia meter is at a low level at which the denitrification is not required in the aforesaid water treatment sequence, the water treatment can automatically be terminated without unnecessary implementation of the electrolysis. On the other hand, if the ammonia concentration is at a high level at which the denitrification is required, it is automatically judged that the electrolysis should be continued or started.

Thus, the seventh inventive water treatment apparatus has an advantageous construction for efficiently performing the aforesaid water treatment sequence through automatic control.

As described above, the use of the seventh water treatment apparatus makes it possible to detect the completion of the decomposition of ammonia in the aforesaid water treatment sequence.

That is, such a detection method is characterized by: introducing water to be treated into the electrolytic bath of the seventh water treatment apparatus: measuring the ammonia concentration of the water being treated while energizing the electrolytic bath; and detecting the completion of the decomposition of ammonia on the basis of the measured ammonia concentration level.

In the aforesaid water treatment sequence, the detection method includes the step of measuring the ammonia concentration of the water being treated by the ammonia meter for monitoring the change in the ammonia concentration of the water with time. The detection method is an advantageous method for automatically determining the completion of the water treatment in the automatic control of the water treatment apparatus.

(Eighth Water Treatment Apparatus)

An eighth water treatment apparatus according to the present invention for solving the aforesaid problems comprises:
an anode which generates chlorine from chloride ions through an electrochemical reaction;
a cathode;
an electrolytic bath containing the anode and the cathode;
an ammonia meter which measures an ammonia concentration of water contained in the electrolytic bath for treatment; and
effective chlorine generating capability detecting means which detects degradation of an effective chlorine generating capability of the anode on the basis of a measurement value of the ammonia meter.

The eighth water treatment apparatus includes the ammonia meter and the effective chlorine generating capability detecting means. Therefore, the concentration of ammonia contained in the water being treated can be measured for monitoring a change in the concentration with time, while the aforesaid water treatment sequence is performed. Further, the degradation of the effective chlorine generating capability of the anode can automatically be detected on the basis of the measured concentration level and the concentration change with time.

For example, the amount of effective chlorine required for decomposing ammonia into nitrogen gas in the water being treated for removal of ammonia is first estimated on the basis of the measurement value of the ammonia meter. Then, the amount of hypochlorous acid (ions) corresponding to the required effective chlorine amount is estimated. The amount of chloride ions required according to the estimated hypochlorous acid (ion) amount is estimated on the basis of data of the ammonia generating capability (nitrate (nitrite) ion reduction capability) of the anode, and the chloride ions are introduced into the electrolytic bath. If the ammonia concentration is not decreased by a reaction (denitrification) with the effective chlorine such as hypochlorous acid (ions) or the decrease rate is lower than expected when the chloride ions are introduced, it is judged that the effective chlorine generating capability of the anode is degraded.

For easier and more accurate judgment on the degradation of the effective chlorine generating capability of the anode, the eighth water treatment apparatus preferably further comprises:
required effective chlorine amount estimating means which estimates the effective chlorine amount required for decomposing ammonia into nitrogen gas on the basis of the measurement value of the ammonia meter,
wherein the effective chlorine generating capability detecting means detects the degradation of the effective chlorine generating capability of the anode on the basis of a difference between the required effective chlorine amount estimated by the required effective chlorine amount estimating means and an actually required effective chlorine amount.

The eighth water treatment apparatus and the preferred embodiment thereof each have an advantageous construction for efficiently performing the aforesaid water treatment sequence through automatic control.

As described above, the use of the eighth water treatment apparatus makes it possible to automatically detect the degradation of the effective chlorine generating capability of the anode in the aforesaid water treatment sequence.

That is, a method for detecting the degradation of the generating capability is characterized by: introducing water to be treated into the electrolytic bath of the eighth water treatment apparatus; measuring the ammonia concentration of the water being treated while energizing the electrolytic bath; and detecting the degradation of the effective chlorine generating capability of the anode on the basis of the measured ammonia concentration level.

In the aforesaid water treatment sequence, the detection method includes the step of measuring the ammonia concentration of the water being treated by the ammonia meter for monitoring the change in the ammonia concentration of the water with time.

For easier and more accurate judgment of the degradation of the effective chlorine generating capability of the anode, the detection method preferably comprises: estimating the effective chlorine amount required for decomposing ammonia into nitrogen gas on the basis of the measured ammonia concentration level; and detecting the degradation of the effective chlorine generating capability of the anode on the basis of the difference between the estimated required effective chlorine amount and the actually required effective chlorine amount.

These detection methods are advantageous methods for automatically judging the degradation of the effective chlorine generating capability of the anode through the automatic control of the water treatment apparatus.

The aforesaid fourth water treatment apparatus is adapted to detect the degradation of the residual chlorine generating capability of the anode on the basis of the measurement value of the residual chlorine sensor, and the preferred embodiment thereof is adapted to estimate the residual chlorine amount required for the decomposition of ammonia on the basis of the residual chlorine concentration of the water being treated and the nitrate (nitrite) ion amount, and detect the degradation of the residual chlorine generating capability of the anode on the basis of the difference between the estimated required residual chlorine amount and the actually required residual chlorine amount. The eighth water treatment apparatus is adapted to detect the degradation of the effective chlorine generating capability of the anode on the basis of the measurement value of the ammonia meter, and the preferred embodiment thereof is adapted to estimate the effective chlorine amount required for the decomposition on the basis of the measured ammonia concentration level of the water being treated, and detect the degradation of the effective chlorine generating capability of the anode on the basis of the difference between the estimated required effective chlorine amount and the actually required effective chlorine amount.

Alternatively, the degradation of the residual chlorine (effective chlorine) generating capability of the anode may be detected on the basis of the measured nitrate (nitrite) ion amount in the water being treated, the required residual chlorine (effective chlorine) amount estimated from the ion amount and the actually required residual chlorine (effective chlorine) amount.

A water treatment apparatus suitable for such a case comprises:
an anode which generates chlorine from chloride ions through an electrochemical reaction;
a cathode;
an electrolytic bath containing the anode and the cathode;
required chloride ion amount estimating means which estimates an amount of residual chlorine required for decomposing ammonia as a reduction product of nitrate (nitrite) ions into nitrogen gas on the basis of an amount of the nitrate (nitrite) ions in water contained in the electrolytic bath for treatment, and further estimates a chloride ion amount required for generating the residual chlorine; and
residual chlorine generating capability detecting means which detects degradation of a residual chlorine generating capability of the anode on the basis of a difference between the required chloride ion amount estimated by the estimating means and an actually employed residual chloride ion amount.

The water treatment apparatus can detect the degradation of the residual chlorine (effective chlorine) generating capability of the anode without the use of the residual chlorine sensor and the ammonia meter. In the water treatment apparatus, the nitrate (nitrite) ion amount in the water being treated may be determined, for example, through actual measurement by the nitrate (nitrite) ion meter, or through estimation on the basis of a control electric current level of the electrolytic bath and a measured hydrogen gas concentration level in the electrolytic bath at the electric current level.

The use of the water treatment apparatus makes it possible to automatically detect the degradation of the residual chlorine (effective chlorine) generating capability of the anode in the aforesaid water treatment sequence. That is, a method for detecting the degradation of the generating capability is characterized by: introducing water to be treated into the electrolytic bath of the water treatment apparatus; estimating the residual chlorine amount required for decomposing ammonia as the reduction product of the nitrate (nitrite) ions on the basis of the nitrate (nitrite) ion amount in the water being treated; estimating the chloride ion amount required for generating the residual chlorine; and detecting the degradation of the residual chlorine generating capability of the anode on the basis of the difference between the estimated required chloride ion amount and the actually required chloride ion amount. This detection method is an advantageous method for automatically detecting the degradation of the residual chlorine (effective chlorine) generating capability of the anode in the automatic control of the water treatment apparatus.

In the inventive water treatment apparatuses, the control electric current of the electrolytic bath is applied by a DC power source, and power supply controlling means is preferably adapted to control power supply for the energization by an AD input electric current level and/or a DC output electric current level of the power source.

In this case, the supply source may have a smaller capacity. In addition, a material for the electrolytic bath may have a lower heat resistance, as long as its corrosive resistance is high. Particularly, hard vinyl chloride or the like may be employed, which is less costly and excellent in workability. Thus, the costs of the water treatment apparatus can be reduced.

In the inventive water treatment apparatuses, a water level sensor of a non-float type is preferably employed as means for controlling the level of the water being treated. The water level sensor of the non-float type is less liable to malfunction than a water level sensor of a float type. If a sensor of an electrode type is employed, scale is less liable to adhere on the sensor. Therefore, the sensor is advantageous in that the malfunction is further less liable to occur and the electrical control thereof is easier. Advantageously, a multi-point control is also possible.

The inventive water treatment apparatuses preferably further comprise an ozone generator.

When ozone generated by the ozone generator is introduced into the water being treated in the electrolytic bath, a reaction represented by the following formula (5) occurs to release an oxygen atom. The released oxygen atom reacts with ammonia in the water. As a result, an ammonia oxidation/denitrification reaction represented by the following reaction formula (6) occurs to generate nitrogen gas. The following reaction formula (7) shows an ammonia oxidation/denitrification reaction by ozone.
O₃→O₂+O (5)
2NH₃(aq)+3(O)N₂↑+3H₂O (6)
2NH₃(aq)+3O₂→N₂↑+3H₂O+3O₂ (7)

Therefore, the provision of the ozone generator in the inventive water treatment apparatuses allows for speedy denitrification.

### BRIEF DESCRIPTION OF THE DRAWINGS

FIG. 1 is a schematic diagram illustrating a water treatment apparatus according to one embodiment of the present invention;

FIG. 2 is a schematic diagram illustrating a water treatment apparatus according to another embodiment of the present invention;

FIG. 3 is a schematic diagram illustrating a water treatment apparatus according to further another embodiment of the present invention;

FIG. 4 is a schematic diagram illustrating a water treatment apparatus according to still another embodiment of the present invention;

FIG. 5 is a flow chart illustrating one exemplary water treatment process employing the inventive water treatment apparatus;

FIG. 6 is a flow chart illustrating a continuation of FIG. 5;

FIG. 7 is a flow chart illustrating another exemplary water treatment process employing the inventive water treatment apparatus;

FIG. 8 is a flow chart illustrating a continuation of FIG. 7;

FIG. 9 is a flow chart illustrating further another exemplary water treatment process employing the inventive water treatment apparatus; and

FIG. 10 is a flow chart illustrating a continuation of FIG. 9.

### EMBODIMENTS OF THE INVENTION

Water treatment apparatuses according to the present invention will hereinafter be described in detail with reference to schematic diagrams illustrating the water treatment apparatuses and flow charts illustrating water treatment processes employing the apparatuses.

[Embodiments of Water Treatment Apparatuses]

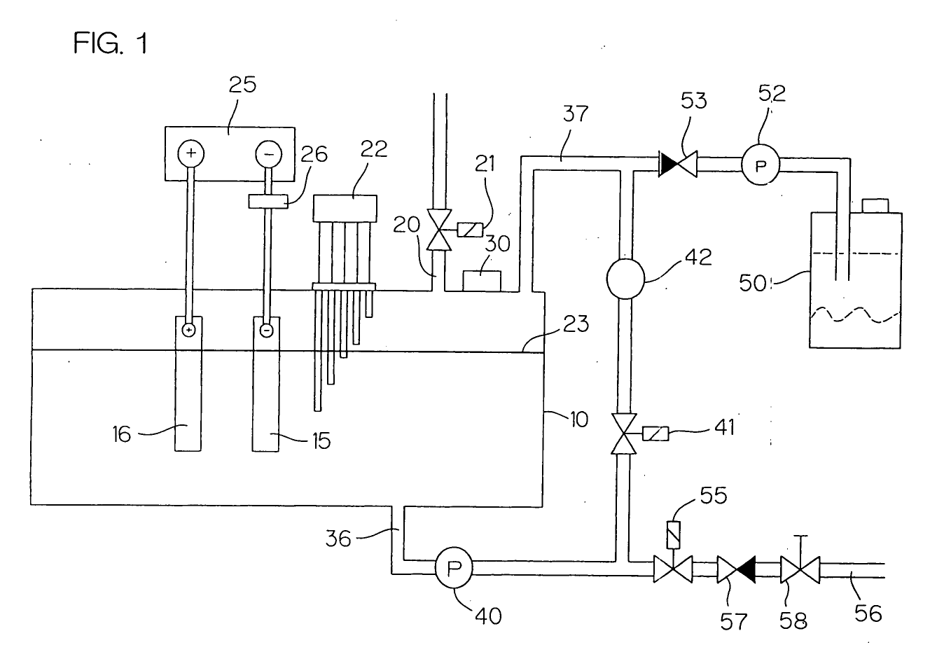

FIGS. 1 to 4 illustrate water treatment apparatuses according to embodiments of the present invention.

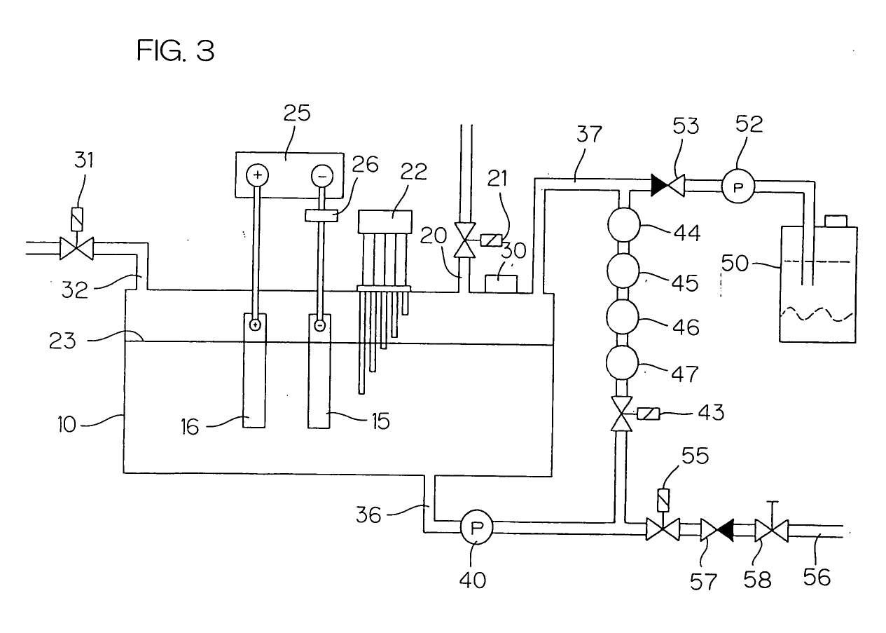

Water treatment apparatuses shown in FIGS. 1 and 3 each include an electrolytic bath 10 of a so-called non-membrane type. A cathode 15, an anode 16 and a water level sensor 22 are provided in the electrolytic bath 10.

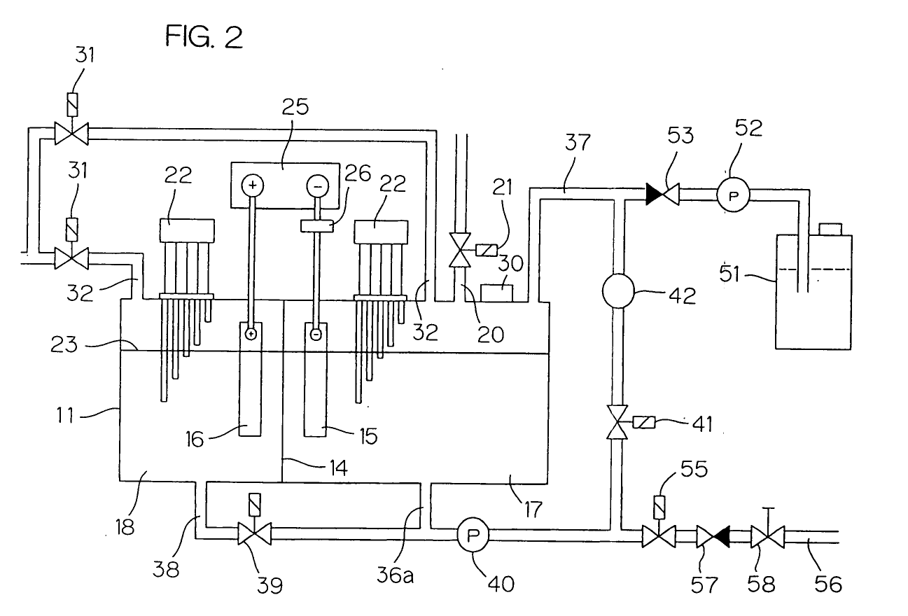

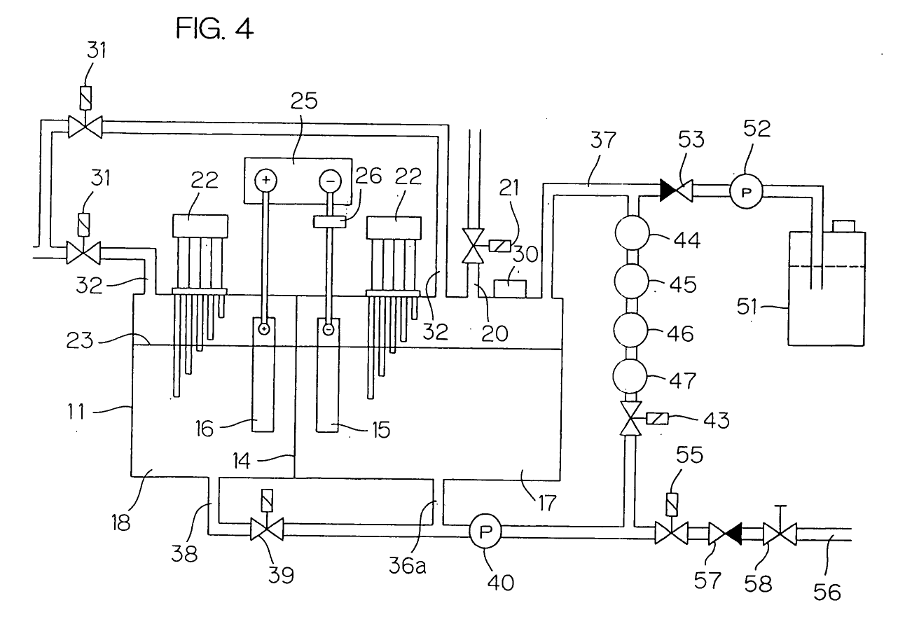

Water treatment apparatuses shown in FIGS. 2 and 4 each include an electrolytic bath 11 of a so-called membrane partition type. The electrolytic bath 11 is partitioned into a cathode reaction area 17 and an anode reaction area 18 by a membrane 14 which is impermeable to nitrate (nitrite) ions but permeable to hydrogen ions (H⁺). A cathode 15 and an anode 16 are provided in the cathode reaction area 17 and the anode reaction area 18, respectively.

One electrode pair consisting of the cathode (negative electrode) 15 and the anode (positive electrode) 16 is illustrated in FIGS. 1 to 4, but not limitative. In the inventive water treatment apparatuses, a plurality of electrode pairs may be provided in the electrolytic bath.

In the present invention, examples of the cathode which reduces nitrate (nitrite) ions through an electrochemical reaction include cathodes of a conductor containing a group-11 or group-12 element such as brass, copper or zinc, and cathodes of a conductor coated with a group-11 or group-12 element. Among these, brass is preferred in the present invention, because it has a superior nitrate ion reducing property. On the other hand, if the cathode is not required to have a nitrate (nitrite) ion reducing capability, the type of the cathode is not particularly limited. Besides the aforesaid exemplary cathodes, various known electrodes for electrolysis are usable.

In the present invention, the anode which generates chlorine from chloride ions through an electrochemical reaction is not particularly limited, but examples thereof include metal electrodes produced by coating a titanium substrate with a group-10 element such as platinum or palladium, ruthenium or iridium by plating or sintering, a carbon electrode and a ferrite electrode. On the other hand, if the anode is not required to have a chlorine generating capability, the type of the anode is not particularly limited. Besides the aforesaid exemplary anodes, various known electrodes for electrolysis are usable.

In the water treatment apparatuses shown in FIGS. 2 and 4, a membrane which is impermeable to nitrate (nitrite) ions but permeable to hydrogen ions (H⁺) is employed as the membrane 14 for partitioning the electrolytic bath 11 into the cathode reaction area 17 and the anode reaction area 18. Examples of a membrane which is impermeable to ammonia and hypochlorous acid (ions) but permeable to electrons include cation exchange membranes and membrane filters (e.g., ultra-filtration membranes).

A DC power source 25 for supplying a DC electric current is connected to the cathode 15 and the anode 16, and an electric current sensor 26 is provided on an interconnection of the cathode 15. The level of the DC electric current can be measured by the electric current sensor 26.

In the water treatment apparatuses shown in FIGS. 1 to 4, the electrolytic bath 10, 11 has an inlet port 20 for introducing water to be treated. The water to be treated is introduced into the electrolytic bath 10, 11 through the inlet port 20 by opening an electromagnetic valve 21. The inlet port 20 for the water to be treated is not limited to this arrangement, but is preferably provided in the vicinity of the cathode 15 for enhancement of the efficiency of the reduction of nitrate (nitrite) ions and the decomposition and removal of ammonia.

In the water treatment apparatuses shown in FIGS. 1 to 4, a pipe 32 for introducing diluent water such as tap water into the electrolytic bath 10, 11 and an electromagnetic valve 31 for controlling the supply of the diluent water are provided along with the inlet port 20 for introducing the water to be treated. In the water treatment apparatuses shown in FIGS. 2 and 4 which include the electrolytic bath 11 of the membrane partition type, the pipe 32 (inlet port) for the diluent water is provided in each of the cathode reaction area 17 and the anode reaction area 18 of the electrolytic bath 11.

In the case of the electrolytic bath 10 of the non-membrane type, the water level sensor 22 is preferably disposed in the vicinity of the cathode 15. In the case of the electrolytic bath 11 of the membrane partition type, the water level sensor 22 is disposed in each of the cathode reaction area 17 and the anode reaction area 18. The water level sensor 22 may be a float liquid level meter, but is preferably a non-float liquid level meter as shown in FIGS. 1 to 4. The non-float water level sensor, particularly, of an electrode type is advantageous in that scale is less liable to adhere on the sensor and malfunction is less liable to occur as compared with the float type sensor. Advantageously, multi-point control is also possible. In addition, it is easy to electrically control the liquid level meter of the electrode type.

In the water treatment apparatuses shown in FIGS. 1 to 4, a hydrogen gas sensor 30 is provided in the electrolytic bath 10, 11, and the concentration of hydrogen gas generated by the electrolysis is measured by the sensor 30. In the case of the electrolytic bath 11 of the membrane partition type shown in FIGS. 2 and 4, the hydrogen gas sensor 30 is disposed in the cathode reaction area 17 of the electrolytic bath 11.

In the case of the water treatment apparatuses including the electrolytic bath 10 of the non-membrane type as shown in FIGS. 1 and 3, examples of ion supply means for supplying chloride ions and/or hypochlorous acid (ions) into the water being treated in the electrolytic bath 10 include a saline solution tank 50 and a hypochlorous acid (salt) tank. A saline solution supplied into the electrolytic bath 10 from the saline solution tank 50 is a source of a free residual chlorine component (effective chlorine) having an oxidation power for causing the denitrification to proceed as represented by the aforesaid reaction formula (4).

In the cases shown in FIGS. 1 and 3, the saline solution is supplied into the electrolytic bath 10 from the saline solution tank 50 by driving a feed pump 52. A reference character 53 denotes a check valve for preventing back flow.

In the water treatment apparatuses including the electrolytic bath 11 of the membrane partition type as shown in FIGS. 2 and 4, ion supply means is provided which is capable of directly supplying a residual chlorine component such as hypochlorous acid (ions) into the electrolytic bath 11. A hypochlorous acid (salt) tank 51 is typically employed as the ion supply means.

Where the electrolytic bath 11 of the membrane partition type shown in FIGS. 2 and 4 is employed, hypochlorous acid (ions) supplied from the hypochlorous acid (salt) tank 51 directly acts as a free residual chlorine component (effective chlorine) in the cathode reaction area 17. The ion supply means such as the hypochlorous acid (salt) tank 51 is connected to the cathode reaction area 17 of the electrolytic bath 11. The hypochlorous acid (ions) is supplied into the electrolytic bath 11 from the tank 51 by driving a feed pump 52. A reference character 53 denotes a check valve for preventing back flow as in FIGS. 1 and 3.

In the water treatment apparatuses shown in FIGS. 1 to 4, an ozone generator may be provided along with or instead of the saline solution tank 50 or the hypochlorous acid (salt) tank 51. Ozone generated by the ozone generator is directly introduced into the water being treated in the electrolytic bath 10 or into the water being treated in the cathode reaction area 17 through a pipe.

The electrolytic bath 10 of the water treatment apparatus shown in FIG. 1 is provided with a pipe 36 for introducing the water being treated (or treated water) into a residual chlorine sensor 42 or for draining treated water through a drain port 56.

The electrolytic bath 11 of the water treatment apparatus shown in FIG. 2 is provided with pipes 36a and 38 for introducing the water being treated (or treated water) in the reaction areas 17 and 18 into a residual chlorine sensor 42 or for draining treated water from the cathode reaction area 17 and the anode reaction area 18 through a drain port 56. The pipe 38 is provided with an electromagnetic valve 39 for controlling the draining of the water from the anode reaction area 18.

The electrolytic bath 10 of the water treatment apparatus shown in FIG. 3 is provided with a pipe 36 for introducing the water being treated (or treated water) into a chloride ion meter 44, a nitrate ion meter 45, a nitrite ion meter 46 and an ammonia ion meter 47 or for draining treated water through a drain port 56.

The electrolytic bath 11 shown in FIG. 4 is provided with pipes 36a and 38 for introducing the water being treated (or treated water) in the reaction areas 17 and 18 into meters 44, 45, 46, 47 or for draining treated water from the cathode reaction area 17 and the anode reaction area 18 through a drain port 56. The pipe 38 is provided with an electromagnetic valve 39 for controlling the draining of the water from the anode reaction area 18.

In the water treatment apparatuses shown in FIGS. 1 to 4, the pipe 36, 36a is provided with a circulation pump 40 for supplying the water being treated (treated water) to the sensor 42 and the drain port 56, an electromagnetic valve 41 for controlling the water passage to the residual chlorine sensor 42, and an electromagnetic valve 55 for controlling the water passage to the drain port 56.

The water supplied to the residual chlorine sensor 42 through the pipe 36, 36a is circulated into the electrolytic bath 10 through a pipe 37. In the water treatment apparatuses shown in FIGS. 1 and 2, a saline solution or hypochlorous acid (ion) supply channel extending from the saline solution tank 50 or the hypochlorous acid (salt) tank 51 is connected to the pipe 37. Thus, the connection between the tank 50, 51 and the electrolytic bath 10, 11 is established.

The pipe 36, 36a is provided with a circulation pump 40 for supplying the water being treated (treated water) to the respective meters 44, 45, 46, 47 or the drain port 56, an electromagnetic valve 41 for controlling the water passage to the respective meters 44, 45, 46, 47, and an electromagnetic valve 55 for controlling the water passage to the drain port 56. In FIGS. 1 to 4, a reference character 57 denotes a check valve, and a reference character 58 denotes a regulation valve.

The water supplied to the respective meters 44, 45, 46, 47 through the pipe 36, 36a is circulated into the electrolytic bath 10 through a pipe 37. In the water treatment apparatuses shown in FIGS. 3 and 4, a saline solution or hypochlorous acid (ion) supply channel extending from the saline solution tank 50 or the hypochlorous acid (salt) tank 51 is connected to the pipe 37. Thus, the connection between the tank 50, 51 and the electrolytic bath 12, 13 is established.

[Exemplary Water Treatment Processes]

(1) Case Where Control Electric Current for Electrolysis is Variable

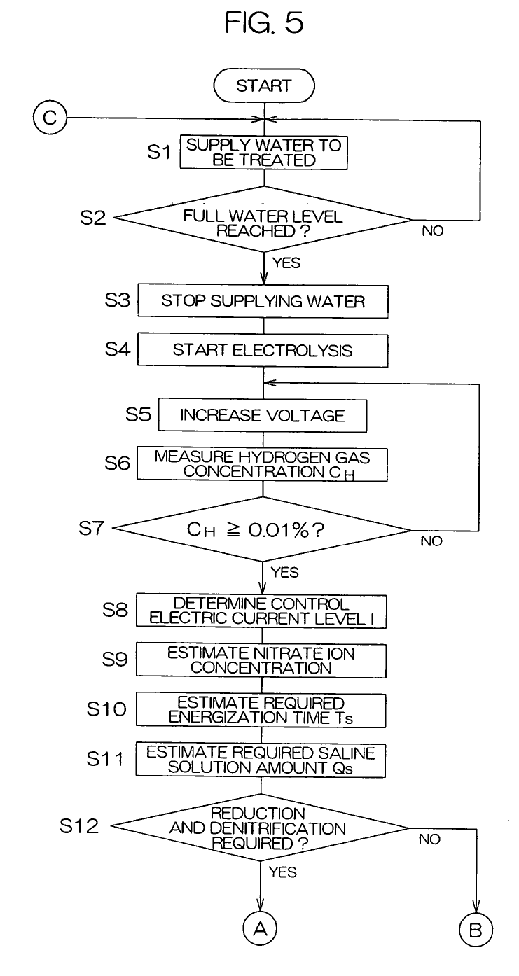

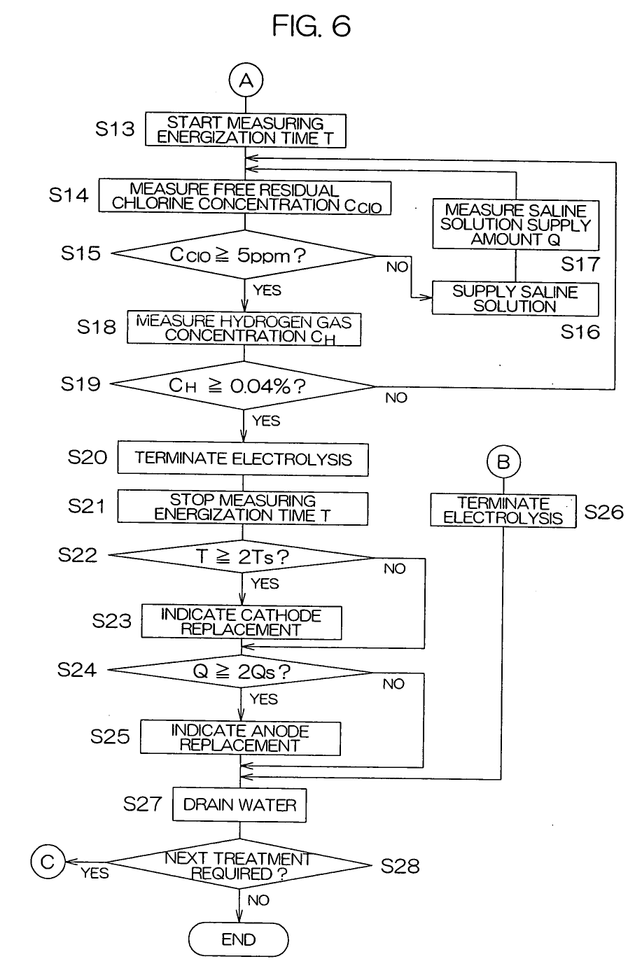

One exemplary water treatment process to be performed with the use of the water treatment apparatus shown in FIG. 1 by employing a variable control electric current for the electrolysis will be described with reference to flow charts shown in FIGS. 5 and 6.

In the water treatment process, water to be treated is first supplied in a state where the electromagnetic valve 21 for the inlet port 20 is opened and the electromagnetic valves on the other flow channels connected to the electrolytic bath 10 (the electromagnetic valve 41 connected to the residual chlorine sensor 42 and the electromagnetic valve 55 connected to the drain port 56) are closed (Step S1).

The level of the water being treated in the electrolytic bath 10 is detected by the water level sensor 22, and it is judged whether a full water level is reached (Step S2). If the level of the water does not reach the full water level 23 yet, the process returns to Step S1 to continue the supply of the water. On the other hand, if the full water level 23 is reached, the electromagnetic valve 21 for the inlet port 20 is closed to stop the supply of the water (Step S3). A variable electric current is applied to the electrode pair (the cathode 15 and the anode 16) in the electrolytic bath 10. Thus, the electrolysis of the water is started (Step S4) for an initial electrolysis operation.

In the initial electrolysis operation, the voltage of the DC power source 25 is gradually increased for determination of the level I of a control electric current to be applied to the electrode pair in the subsequent steady electrolysis operation (Step S5). At the same time, the hydrogen gas sensor 30 starts measuring the concentration C_{H} of hydrogen gas in the electrolytic bath 10 (Step S6).

If the hydrogen gas concentration C_{H} is lower than 0.01%, the process returns to Step S5 to continuously increase the voltage and, if the hydrogen gas concentration C_{H} is not lower than 0.01%, the increase of the voltage is stopped (Step S7). When the increase of the voltage is stopped, the control electric current level I is determined by multiplying an electric current level I₀ observed at the stop by 0.8 (Step S8). Thereafter, the electric current level applied to the electrode pair is fixed at the control electric current level I for the steady electrolysis operation.

In the steady electrolysis operation, the nitrate (nitrite) ion concentration of the water being treated is estimated by the nitrate ion concentration estimating means (Step S9), and the energization time required for reducing nitrate (nitrite) ions to decrease the nitrate (nitrite) ion amount to not greater than a permissible level (required energization time Ts) is estimated on the basis of the estimated nitrate ion concentration by the required energization time estimating means (Step S10). Further, the amount of the saline solution required for decomposing ammonia generated by the reduction of the nitrate (nitrite) ions into nitrogen gas (required saline solution amount Qs) is estimated (Step S11).

Data of a correlation among the control electric current level I, the nitrate (nitrite) ion concentration and the required saline solution amount preliminarily prepared is employed for the estimation. Particularly, the estimation of the nitrate (nitrite) ion amount in Step S9 is carried out in the same manner as described for the first inventive water treatment apparatus and the first detection method.

A measurement value obtained through measurement by a nitrate ion meter or a nitrite ion meter may be employed as the nitrate ion amount in the water being treated instead of the value estimated by the nitrate ion concentration estimating means in Step S9.

In Step S11, the required saline solution amount Qs is estimated. This is because chloride ions are supplied from the saline solution tank 50 into the electrolytic bath 10 shown in FIG. 1. If the hypochlorous acid (salt) tank 51 shown in FIG. 2 is provided instead of the saline solution tank 50, a required hypochlorous acid amount is estimated instead of the required saline solution amount Qs. The use of the hypochlorous acid (salt) tank 51 is more effective in the case where the anode having no chlorine generating capability is employed.

After the estimated nitrate ion amount is obtained in Step S9, it is judged on the basis of the estimated nitrate ion amount whether the electrolysis is to be continued or terminated (Step S12). If it is judged that the reduction and the denitrification are still needed with a greater estimated nitrate ion amount, the electrolysis is continued for the reduction of nitrate (nitrite) ions and the decomposition and removal of ammonia.

If the electrolysis is continued, a timer is started at the same time to start measuring the energization time T required for the reduction of the nitrate (nitrite) ions (Step S13). Further, the water being treated in the electrolytic bath 10 is introduced into the residual chlorine sensor 42 by the circulation pump 40 for the measurement of the residual chlorine concentration C_{ClO} of the water in a state where the electromagnetic valve 41 for the water passage to the residual chlorine sensor 42 is opened and the electromagnetic valve 55 connected to the drain port 56 is closed (Step S14).

In the reduction and the denitrification, an adjustment should be made so that ammonia generated by the reduction is decomposed into nitrogen gas simultaneously with the generation thereof for proper denitrification. Therefore, the reduction completion detecting means judges whether or not the supply of the saline solution is required on the basis of the result of the measurement of the residual chlorine concentration by the residual chlorine sensor 42 (Step S15). As a result, if the free residual chlorine concentration of the water should be maintained, the saline solution is supplied into the electrolytic bath 10 from the saline solution tank 50 (Step S16). More specifically, if the residual chlorine concentration is lower than 5 ppm, it is judged that ammonia to be denitrified is still present and, therefore, the saline solution is supplied for maintaining the free residual chlorine concentration of the water. Thereafter, the aforesaid control is continued.

When the saline solution is supplied, the output voltage of the DC power source 25 is automatically adjusted according to the supply amount Q of the saline solution so as not to change the control electric current level I. At this time, the saline solution supply amount Q is accumulated (Step S17).

If the free residual chlorine concentration of the water being treated exceeds the predetermined level in Step S15, the hydrogen gas concentration C_{H} is measured (Step S18). More specifically, if the residual chlorine concentration is not lower than 5 ppm, it is judged that ammonia is sufficiently decomposed to be removed. Therefore, the supply of the saline solution is stopped, and the hydrogen gas concentration C_{H} is measured.

If the hydrogen gas concentration C_{H} is not lower than 0.04% as the result of the measurement, the reduction completion detecting means judges that the nitrate ion concentration and the ammonia concentration of the water being treated are each decreased to a level (not higher than the permissible level) at which neither the reduction nor the denitrification is required (Step S19). Then, the electrolysis is terminated (Step S20) and, at the same time, the measurement by the timer is stopped to determine the required energization time T (Step S21). On the other hand, if the hydrogen gas concentration C_{H} is lower than 0.04%, the reduction completion detecting means judges that nitrate ions and ammonia to be removed are still present in the water being treated (Step S19) and the process returns to Step S14 to perform the subsequent steps again.

The completion of the reduction is detected by the reduction completion detecting means in Steps S15 and S19 and, after the electrolysis is terminated, the energization time T actually required for the reduction and the denitrification is compared with the required energization time Ts estimated in Step S10 (Step S22). If T≧2Ts, the reduction capacity detecting means judges in Step S22 that the reduction capability of the cathode is degraded, and an indication for the replacement of the cathode is given (Step S23). If T<2Ts, the Step S22 is skipped, and anode replacement indicating means judges whether or not the replacement of the anode is required.

In turn, the accumulative amount Q of the saline solution actually supplied for the reduction and the denitrification (actual supply amount) is compared with the required saline solution amount Qs estimated in Step S11 (Step S24). If Q≧2Qs, it is judged that the capability of the anode for generating the free residual chlorine component is degraded, and an indication for the replacement of the anode is given (Step S25). If Q<2Qs, Step 24 is skipped to perform a water draining operation.

Finally, the electromagnetic valve 41 for the water passage to the residual chlorine sensor 42 is closed, and the electromagnetic valve 55 for the drain port 56 is opened to drain the treated water from the electrolytic bath 10 through the drain port 56 (Step S27). The draining of the treated water is achieved by driving the circulation pump 40.

On the other hand, if it is judged that the nitrate ion concentration of the water obtained in Step S9 is at a low level (not higher than the permissible level) at which neither the reduction nor the denitrification is required (Step S12), the electrolysis is terminated (Step S26), and the water draining operation is performed (Step S27).

If water requiring the denitrification is to be newly treated after the water draining operation in Step S27, the process returns to Step S1 to repeat the process sequence. On the other hand, if there is no water requiring the denitrification, the process ends (Step S28).

In the denitrification process shown in FIGS. 5 and 6, the estimation of the required time Ts (Step S10), the estimation of the required saline solution amount Qs (Step S11) and the start and end of the measurement of the required energization time T (Steps S13, S21) may be obviated, if the judgments on the replacement of the cathode and the replacement of the anode (Steps S22, S24) are not made after the termination of the electrolysis (Step S20).

Where the ozone generator is provided along with or instead of the saline solution tank 50 or the hypochlorous acid (salt) tank, ozone may be supplied together with or instead of the saline solution (or hypochlorous acid (salt)) to the water being treated in Step S16. In this case, there is a possibility that the water being treated is excessively alkalized to excessively retard or stop the electrochemical reaction. Therefore, an acidic solution such as of hydrochloric acid or sulfuric acid is preferably supplied to the water being treated.

Where the electrolytic bath 11 of the membrane partition type shown in FIG. 2 is employed instead of the water treatment apparatus shown in FIG. 1 and the level of the electric current for the energization of the electrolytic bath 11 (control electric current level) is variable, the water treatment process is performed according to substantially the same flow as shown in the flow charts of FIGS. 5 and 6.

Where an electrode which generates no free residual chlorine (effective chlorine) is employed as the anode 16, the judgment on the replacement of the anode (Step S24) is obviated after the termination of the electrolysis (Step S21). Accordingly, the estimation of the required saline solution amount Qs (Step S11) is also obviated.

(2) Case Where Control Electric Current Level for Electrolysis is Fixed

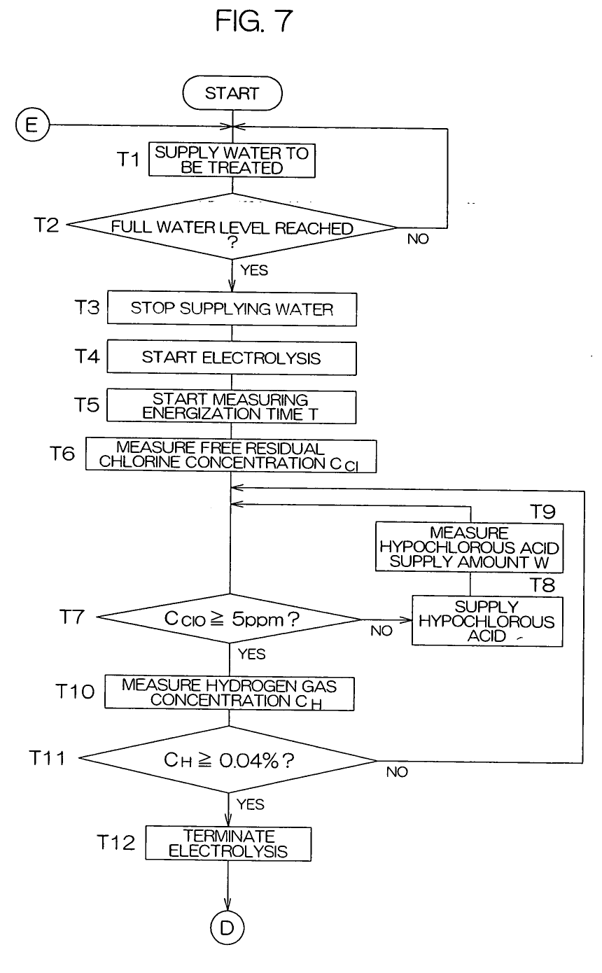

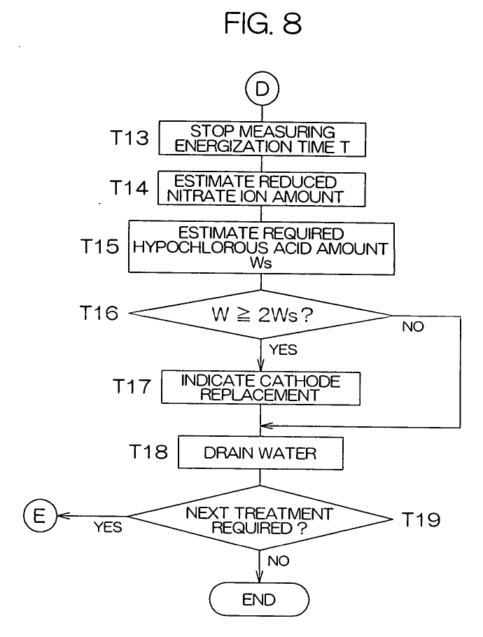

Another exemplary water treatment process to be performed with the use of the water treatment apparatus shown in FIG. 2 by employing a fixed control electric current for the electrolysis will be described with reference to flow charts shown in FIGS. 7 and 8.

In the water treatment process, the supply of the water to be treated is started in a state where the electromagnetic valve 21 for the inlet port 20 is opened and the electromagnetic valves on the other flow channels connected to the electrolytic bath 11 (the electromagnetic valve 41 connected to the residual chlorine sensor 42 and the electromagnetic valve 55 connected to the drain port 56) are closed (Step T1).

The level of the water being treated in the electrolytic bath 10 is detected by the water level sensor 22, and it is judged whether a full water level 23 is reached (Step T2). If the level of the water does not reach the full water level 23 yet, the process returns to Step T1 to continue the supply of the water. On the other hand, if the full water level 23 is reached, the electromagnetic valve 21 for the inlet port 20 is closed to stop the supply of the water (Step T3), and then an electric current is applied to the electrode pair (the cathode 15 and the anode 16) in the electrolytic bath 11. With the electric current level for the energization being fixed, the electrolysis is started by the start of the energization (Step T4). At the same time, a timer is started to start the measurement of the energization time T for the energization of the electrolytic bath (Step T5).

Further, the water being treated in the electrolytic bath 11 is introduced into the residual chlorine sensor 42 by the circulation pump 40 for the measurement of the residual chlorine concentration C_{ClO} of the water in a state where the electromagnetic valve 41 for the water passage to the residual chlorine sensor 42 is opened and the electromagnetic valve 55 connected to the drain port 56 is closed (Step T6).

In the reduction and the denitrification, an adjustment should be made so that ammonia generated by the reduction is decomposed into nitrogen gas simultaneously with the generation thereof for proper denitrification. Therefore, hypochlorous acid (ions) is supplied into the cathode reaction area 17 of the electrolytic bath 11 from the hypochlorous acid (salt) tank 51 as required (Step T8) on the basis of the result of the measurement of the residual chlorine concentration by the residual chlorine sensor 42 (Step T7) for maintaining the free residual chlorine concentration of the water being treated. More specifically, if the residual chlorine concentration is lower than 5 ppm, it is judged that ammonia to be denitrified is still present and, therefore, the hypochlorous acid (ions) is supplied for maintaining the free residual chlorine concentration of the water.

When the hypochlorous acid (ions) is supplied, the output voltage of the DC power source 25 is automatically adjusted according to the supply amount W of the hypochlorous acid (ions) so as not to change the control electric current level. The supply amount W of the hypochlorous acid (ions) is accumulated (Step T9).

Thereafter, the aforesaid control is continued. If the residual chlorine concentration is not lower than 5 ppm, the supply of the hypochlorous acid (ions) is stopped, and the hydrogen gas concentration C_{H} is measured (Step T10). As a result, if the hydrogen gas concentration C_{H} is not lower than 0.04%, it is judged that the nitrate ion concentration and the ammonia concentration of the water being treated are each decreased to a level (not higher than a permissible level) at which neither the reduction nor the denitrification is required (Step T11). Then, the electrolysis is terminated (Step T12) and, at the same time, the measurement of the energization time T is stopped (Step T13). On the other hand, if the hydrogen gas concentration C_{H} is lower than 0.04%, it is judged that nitrate ions and ammonia to be removed are present in the water being treated (Step T11), and the process returns to Step T7 to perform the subsequent steps again.

After the electrolysis is terminated in Step T12, the amount of reduced nitrate ions (reduced nitrate ion amount) is estimated on the basis of the energization time T actually required for the reduction and the denitrification and the control electric current level I for the electrolysis (Step T14), and the amount Ws of hypochlorous acid (ions) required for oxidizing ammonia generated by the reduction for the denitrification (required hypochlorous acid amount) is estimated on the basis of the estimated reduced nitrate ion amount (Step T15).

In turn, the accumulative amount W of the hypochlorous acid (ions) actually supplied for the reduction and the denitrification (actual supply amount) is compared with the required hypochlorous acid amount Ws estimated in Step T14 (Step T16). If W≧2Ws, it is judged that the reduction capability of the cathode is degraded, and an indication for the replacement of the cathode is given (Step T17). If W<2Ws, Step T17 is skipped to perform a water draining operation.

Finally, the electromagnetic valve 41 for the water passage to the residual chlorine sensor 42 is closed, and the electromagnetic valve 55 for the drain port 56 is opened to drain the treated water from the electrolytic bath 11 through the drain port 56 (Step T18). The draining of the treated water is achieved by driving the circulation pump 40.

If water requiring the denitrification is to be newly treated after the water draining operation in Step T18, the process returns to Step T1 to repeat the process sequence. On the other hand, if there is no water requiring the denitrification, the process ends (Step T19).

In the denitrification process shown in FIGS. 7 and 8, the start and end of the measurement of the required energization time T (Steps T5, T13), the estimation of the reduced nitrate ion amount (Step T14) and the estimation of the required hypochlorous acid amount Ws (Step T15) may be obviated, if the judgment on the replacement of the cathode (Step T16) is not made after the termination of the electrolysis in Step T12.

Where the ozone generator is provided along with or instead of the hypochlorous acid (salt) tank, ozone may be supplied together with or instead of the hypochlorous acid (salt) to the water being treated in Step T8. In this case, there is a possibility that the water being treated is excessively alkalized to excessively retard or stop the electrochemical reaction. Therefore, an acidic solution such as of hydrochloric acid or sulfuric acid is preferably supplied to the water being treated.

(3) Case Where Control Voltage for Electrolysis is Fixed

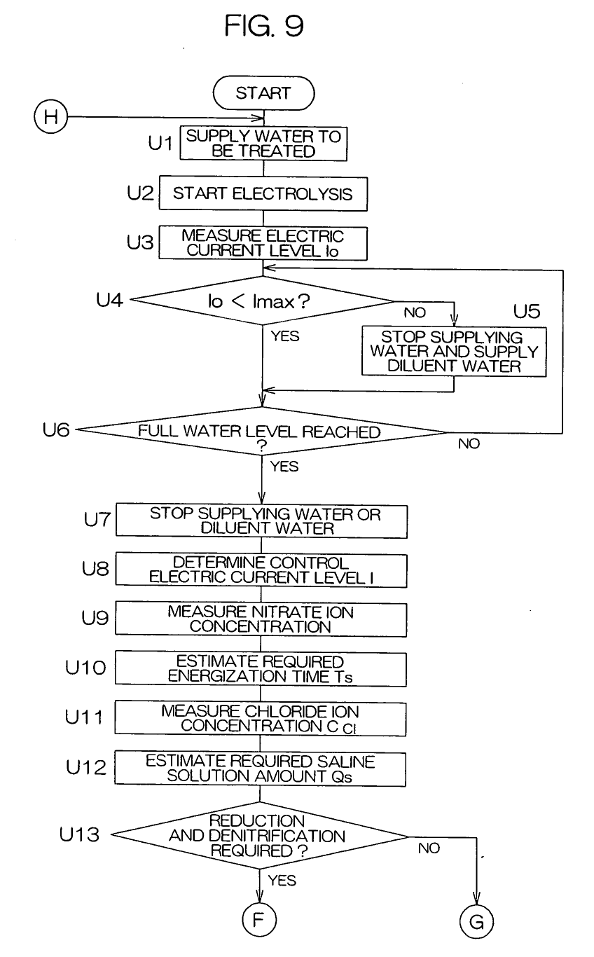

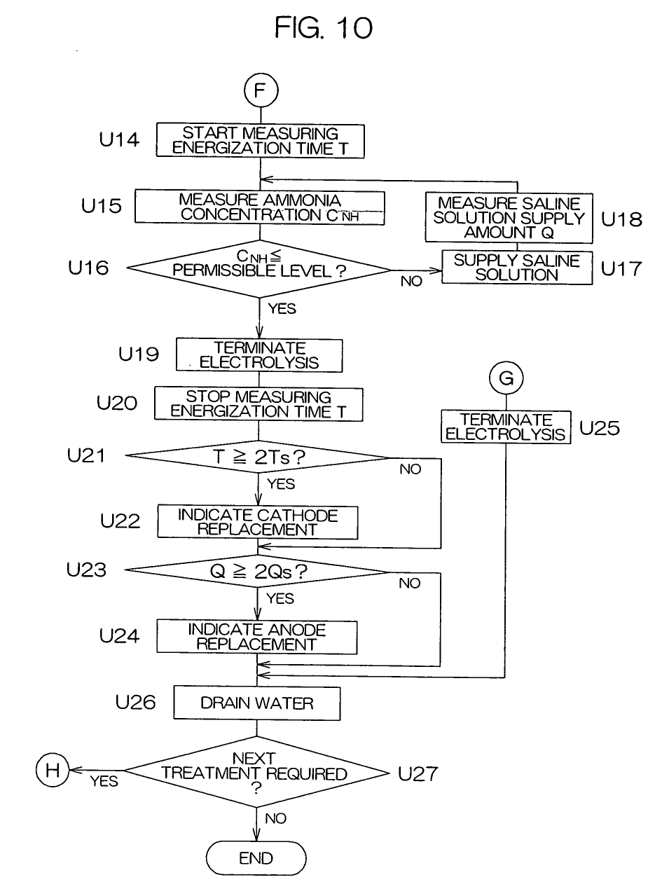

A further another exemplary water treatment process to be performed with the use of the water treatment apparatus shown in FIG. 3 by employing a fixed control voltage for the electrolysis will be described with reference to flow charts shown in FIGS. 9 and 10.

In the water treatment process, the water to be treated is supplied in a state where the electromagnetic valve 21 for the inlet port 20 is opened and the electromagnetic valves on the other flow channels connected to the electrolytic bath 12 (the electromagnetic valve 43 connected to the respective meters 44 to 47 and the electromagnetic valve 55 connected to the drain port 56) are closed (Step U1).

The level of the water being treated in the electrolytic bath 10 is detected by the water level sensor 22. If the level of the water reaches a level required for starting the electrolysis, the energization of the electrolytic bath 12 is started by a constant voltage DC power source 25a to start the electrolysis (Step U2).

At the start of the electrolysis, the level Iₒ of an electric current flowing through the electrolytic bath is measured by the electric current sensor 26 (Step U3), and it is judged whether the electric current level Iₒ is lower than a maximum electric current level Iₘₐₓ permissible for the electrolytic bath 12 (Step U4). If the electric current level Iₒ is lower than the maximum electric current level Iₘₐₓ, the supply of the water to be treated is continued until a full water level is reached. On the other hand, if the electric current level Iₒ reaches the maximum electric current level Iₘₐₓ, the supply of the water to be treated is stopped, and the electromagnetic valve 31 is opened to supply diluent water into the electrolytic bath 12 (Step U5). Thereafter, the process repeatedly returns to Step U4 to perform the subsequent steps until the full water level is reached.

If it is judged on the basis of the detection by the water level sensor 22 that the level of the water in the electrolytic bath 12 reaches the full water level (Step U6), the supply of the water to be treated or the diluent water is stopped (Step U7), and an electric current level observed at this time is employed as the control electric current level I (Step U8). Thereafter, the electric current level for the electrolysis is fixed at the aforesaid control electric current level I, and an initial electrolysis operation is performed.

In the initial electrolysis operation, the electromagnetic valve 55 connected to the drain port 56 is closed, and the electromagnetic valve 41 for the water passage to the chloride ion meter 44, the nitrate ion meter 45, the nitrite ion meter 46 and the ammonia meter 47 is opened. The water being treated in the electrolytic bath 11 is introduced into the aforesaid four meters 44 to 47 by the circulation pump 40.

In turn, the nitrate ion concentration C_{NO}, the chloride ion concentration C_{Cl} and the like of the water being treated are respectively measured by the nitrate ion meter 45, the chloride ion meter 44 and the like (Steps U9, U11), and the energization time Ts required for obviating the need for the reduction and the denitrification (required for decreasing the nitrate (nitrite) ion concentration and the ammonia concentration to not higher than permissible levels) is estimated (Step U10).

Further, a saline solution amount Qs required for denitrifying ammonia generated by the reduction is estimated on the basis of the measured nitrate ion concentration C_{NO} (Step U12).

Data of a correlation among the control electric current I, the nitrate (nitrite) ion concentration, the chloride ion concentration, the required energization time and the required saline solution amount preliminarily prepared is employed for the estimation.

Where the hypochlorous acid (salt) tank is provided instead of the saline solution tank 50, a required hypochlorous acid amount is estimated instead of the required saline solution amount.

After the nitrate (nitrite) ion concentration is measured in Step U9, it is judged on the basis of the nitrate ion concentration whether the electrolysis is to be continued or terminated (Step U13) If it is judged that the reduction and the denitrification are still needed with a higher nitrate ion concentration, the electrolysis is continued for the reduction of nitrate (nitrite) ions and the decomposition and removal of ammonia.

If the electrolysis is continued, a timer is started at the same time to start the measurement of the energization time T required for the reduction and the denitrification (Step U14). Thus, a steady electrolysis operation is started.

In the reduction and the denitrification, an adjustment should be made so that ammonia generated by the reduction is decomposed into nitrogen gas simultaneously with the generation thereof for proper denitrification. Therefore, on the basis of the result of the measurement of the ammonia concentration C_{NH} Of the water by the ammonia meter 47 (Steps U15, 16), the saline solution is supplied into the electrolytic bath 12 from the saline solution tank 50 as required to properly adjust the free residual chlorine concentration of the water being treated (Step U17). The supply amount Q of the saline solution is accumulated according to the supply of the saline solution (Step U18).

Thereafter, the aforesaid control is continued and, if the ammonia concentration is decreased to not higher than a required concentration level (Step U16), the electrolysis is terminated (Step U19). At the same time, the measurement by the timer is stopped to determine the required energization time T (Step U20).

After the termination of the electrolysis in Step U19, the energization time T actually required for the reduction and the denitrification is compared with the energization time Ts estimated in Step U10 (Step U21). If T≧2Ts, it is judged that the reduction capability of the cathode is degraded, and an indication for the replacement of the cathode is given (Step U22). If T<2Ts, the Step U22 is skipped, and anode replacement indicating means judges whether or not the replacement of the anode is required.

After the termination of the electrolysis in Step U19, the accumulative amount Q of the saline solution actually supplied for the reduction and the denitrification (actual supply amount) is compared with the required saline solution amount Qs estimated in Step U12 (Step U23). If Q≧2Qs, it is judged that the capability of the anode for generating the free residual chlorine component is degraded, and an indication for the replacement of the anode is given (Step U24). If Q<2Qs, Step U24 is skipped to perform a water draining operation.

Finally, the electromagnetic valve 43 for the water passage to the aforesaid four meters 44 to 47 is closed, and the electromagnetic valve 55 for the drain port 56 is opened to drain the treated water from the electrolytic bath 12 through the drain port 56 (Step U26).

On the other hand, if it is judged that the nitrate ion concentration of the water obtained in Step U9 is at a low level at which neither the reduction nor the denitrification is required, the electrolysis is terminated (Steps U13, U25), and the water draining operation is performed (Step U26).

If water requiring the reduction and the denitrification is to be newly treated after the water draining operation in Step U26, the process returns to Step U1 to repeat the process sequence. On the other hand, if there is no water requiring the reduction and the denitrification, the process ends (Step U27).

In the denitrification process shown in FIGS. 9 and 10, the estimation of the required energization time Ts (Step U10), the estimation of the required saline solution amount Qs (Step U12) and the start and end of the measurement of the required energization time T (Steps U14, U20) may be obviated, if the judgments on the replacement of the cathode (Step U22) and the replacement of the anode (Step U24) are not made after the termination of the electrolysis in Step S19.

Where the ozone generator is provided along with or instead of the saline solution tank 50 or the hypochlorous acid (salt) tank, ozone may be supplied together with or instead of the saline solution (or hypochlorous acid (salt)) to the water being treated in Step S15. In this case, there is a possibility that the water being treated is excessively alkalized to excessively retard or stop the electrochemical reaction. Therefore, an acidic solution such as of hydrochloric acid or sulfuric acid is preferably supplied to the water being treated.

Where the electrolytic bath 13 having the cation exchange membrane or the membrane filter 14 shown in FIG. 4 is employed instead of the water treatment apparatus shown in FIG. 3 and the level of the electric current applied for the energization of the electrolytic bath 13 (control electric current level) is fixed, the water treatment process is performed according to substantially the same flow as shown in the flow charts of FIGS. 9 and 10.

Where an electrode which generates no free residual chlorine (effective chlorine) is employed as the anode 16, the judgment on the replacement of the anode (Steps U23, U24) is obviated after the termination of the electrolysis (Step U19). Accordingly, the estimation of the required saline solution amount Qs (Step U12) is also obviated.

1. A water treatment apparatus comprising:
a cathode which reduces nitrate (nitrite) ions through an electrochemical reaction;
an anode;
an electrolytic bath containing the cathode and the anode;
a hydrogen gas sensor which measures a hydrogen gas concentration in the electrolytic bath; and
reduction completion detecting means which detects completion of the reduction of the nitrate (nitrite) ions on the basis of a measurement value of the hydrogen gas sensor and a control electric current level of the electrolytic bath.

2. A water treatment apparatus comprising:
a cathode which reduces nitrate (nitrite) ions through an electrochemical reaction;
an anode;
an electrolytic bath containing the cathode and the anode;
a hydrogen gas sensor which measures a hydrogen gas concentration in the electrolytic bath; and
reduction capability detecting means which detects degradation of a reduction capability of the cathode on the basis of a measurement value of the hydrogen gas sensor.

3. A water treatment apparatus as set forth in claim 2, further comprising:
nitrate (nitrite) ion concentration estimating means which estimates a nitrate (nitrite) ion concentration of water being treated on the basis of the measurement value of the hydrogen gas sensor and a control electric current level of the electrolytic bath; and
required energization time estimating means which estimates an energization time required for reducing nitrate (nitrite) ions contained in the water being treated on the basis of the nitrate (nitrite) ion concentration estimated by the nitrate (nitrite) ion concentration estimating means, the control electric current level, and a level of the reduction capability of the cathode;
wherein the reduction capability detecting means detects the degradation of the reduction capability of the cathode on the basis of a difference between the required energization time estimated by the required energization time estimating means and an actually required energization time.

4. A water treatment apparatus comprising:
an anode which generates chlorine from chloride ions through an electrochemical reaction;
a cathode;
an electrolytic bath containing the anode and the cathode;
a residual chlorine sensor which measures a residual chlorine concentration of water contained in the electrolytic bath for treatment; and
denitrification completion detecting means which detects completion of denitrification on the basis of a measurement value of the residual chlorine sensor.

5. A water treatment apparatus as set forth in claim 4, further comprising:
a hydrogen gas sensor which measures a hydrogen gas concentration in the electrolytic bath;
wherein the denitrification completion detecting means detects the completion of the denitrification on the basis of the measurement value of the residual chlorine sensor and a measurement value of the hydrogen gas sensor.

6. A water treatment apparatus comprising:
an anode which generates chlorine from chloride ions through an electrochemical reaction;
a cathode;
an electrolytic bath containing the anode and the cathode;
a residual chlorine sensor which measures a residual chlorine concentration of water contained in the electrolytic bath for treatment; and
residual chlorine generating capability detecting means which detects degradation of a residual chlorine generating capability of the anode on the basis of a measurement value of the residual chlorine sensor.

7. A water treatment apparatus as set forth in claim 6, further comprising:
required residual chlorine amount estimating means which estimates a residual chlorine amount required for decomposing ammonia as a reduction product of nitrate (nitrite) ions into nitrogen gas on the basis of the measurement value of the residual chlorine sensor and a nitrate (nitrite) ion amount in the water being treated;
wherein the residual chlorine generating capability detecting means detects the degradation of the residual chlorine generating capability of the anode on the basis of a difference between the required residual chlorine amount estimated by the required residual chlorine amount estimating means and an actually required residual chlorine amount.

8. A water treatment apparatus comprising:
a cathode which reduces nitrate (nitrite) ions through an electrochemical reaction;
an anode;
an electrolytic bath containing the cathode and the anode;
a nitrate (nitrite) ion meter which measures a nitrate ion concentration of water contained in the electrolytic bath for treatment; and
reduction completion detecting means which detects completion of the reduction of the nitrate (nitrite) ions on the basis of a measurement value of the nitrate (nitrite) ion meter.

9. A water treatment apparatus comprising:
a cathode which reduces nitrate (nitrite) ions through an electrochemical reaction;
an anode;
an electrolytic bath containing the cathode and the anode;
a nitrate (nitrite) ion meter which measures a nitrate (nitrite) ion concentration of water contained in the electrolytic bath for treatment; and
ammonia generating capability detecting means which detects degradation of an ammonia generating capability of the cathode on the basis of a measurement value of the nitrate (nitrite) ion meter.

10. A water treatment apparatus as set forth in claim 9, further comprising:
required effective chlorine amount estimating means which estimates an effective chlorine amount required for decomposing ammonia resulting from the reduction of the nitrate (nitrite) ions into nitrogen gas on the basis of the measurement value of the nitrate (nitrite) ion meter;
wherein the ammonia generating capability detecting means detects the degradation of the ammonia generating capability of the cathode on the basis of a difference between the required effective chlorine amount estimated by the required effective chlorine amount estimating means and an actually required effective chlorine amount.

11. A water treatment apparatus comprising:
an anode which generates chlorine from chloride ions through an electrochemical reaction;
a cathode;
an electrolytic bath containing the anode and the cathode;
an ammonia meter which measures an ammonia concentration of water contained in the electrolytic bath for treatment; and
decomposition completion detecting means which detects completion of decomposition of ammonia on the basis of a measurement value of the ammonia meter.

12. A water treatment apparatus comprising:
an anode which generates chlorine from chloride ions through an electrochemical reaction;
a cathode;
an electrolytic bath containing the anode and the cathode;
an ammonia meter which measures an ammonia concentration of water contained in the electrolytic bath for treatment; and
effective chlorine generating capability detecting means which detects degradation of an effective chlorine generating capability of the anode on the basis of a measurement value of the ammonia meter.

13. A water treatment apparatus as set forth in claim 12, further comprising:
required effective chlorine amount estimating means which estimates an effective chlorine amount required for decomposing ammonia into nitrogen gas on the basis of the measurement value of the ammonia meter;
wherein the effective chlorine generating capability detecting means detects the degradation of the effective chlorine generating capability of the anode on the basis of a difference between the required effective chlorine amount estimated by the required effective chlorine amount estimating means and an actually required effective chlorine amount.

14. A water treatment apparatus as set forth in claim 1,
wherein the control electric current of the electrolytic bath is applied by a DC power source,
wherein power supply controlling means controls power supply for energization by an AD input electric current level and/or a DC output electric current level of the power source.

15. A water treatment apparatus as set forth in claim 1, further comprising an ozone generator.

16. A water treatment apparatus as set forth in claim 2,
wherein the control electric current of the electrolytic bath is applied by a DC power source,
wherein power supply controlling means controls power supply for energization by an AD input electric current level and/or a DC output electric current level of the power source.

17. A water treatment apparatus as set forth in claim 3,
wherein the control electric current of the electrolytic bath is applied by a DC power source,
wherein power supply controlling means controls power supply for energization by an AD input electric current level and/or a DC output electric current level of the power source.

18. A water treatment apparatus as set forth in claim 2, further comprising an ozone generator.

19. A water treatment apparatus as set forth in claim 3, further comprising an ozone generator.

20. A water treatment apparatus as set forth in claim 4, further comprising an ozone generator.
